(19) United States
(12) Patent Application Publication
(10) Pub. No.: US 2007/0280718 A1
(43) Pub. Date: Dec. 6, 2007

(54) Printing Device

(75) Inventor: Hideaki Shimizu, Osaka (JP)

Correspondence Address: GROSSMAN, TUCKER, PERREAULT & PFLEGER, PLLC, 55 SOUTH COMMERICAL STREET, MANCHESTER, NH, 03101, US

(73) Assignee: KYOCERA MITA CORPORATION, Osaka (JP)

(21) Appl. No.: 11/422,449

(22) Filed: Jun. 6, 2006

(51) Int. Cl. G03G 15/00

(52) U.S. Cl. 399/82

(57) ABSTRACT

A printing device which receives and prints job-data which includes: a printing unit which prints the job-data; a memory which stores the job-data; a first cassette which feeds paper to the printing unit; a second cassette which feeds paper of different size from paper fed by the first cassette to the printing unit; a first tray in which printed paper is stacked; a second tray which is provided separately from the first tray and printed paper is stacked therein; and a first controller which makes the printing device store one of the job-data in the memory, the one of the job-data being one which is not printed due to paper exhaustion of one of the first cassette and the second cassette, print other job-data which is to be printed using the other cassette, and stack printed paper in the second tray.

### BACKGROUND OF THE INVENTION

1. Field of the Invention

The present invention relates to a printing device, and more particularly, a printing device which is shared by multiple users and receives many print-jobs.

2. Description of Related Art

A conventional printing device (a printer or a multifunctional device including a printer) having a plurality of paper feeding cassettes which can perform printing on a plurality of sizes of paper such as the one shown in FIG. 3 is described. The printing device receives print data sent from a personal computer, and processes and prints these data in order of receiving. In a case where paper of an appropriate size for a datum to be printed is exhausted, it has been a problem that the printing device halts printing until the paper is supplied to a paper feeding cassette.

FIGS. 4A to 5B are diagrams showing printing operations of a printing device of a first related art. FIGS. 4A and 4B are diagrams showing a normal printing operation when paper is not exhausted. FIGS. 5A and 5B are diagrams showing a condition where a printing operation is halted due to paper exhaustion. In a normal operation, when the device receives print-jobs consisting of a print-job for A4 paper DT1, a print-job for B4 paper DT2, a print-job for A4 paper DT3, a print-job for A3 paper DT4, and a print-job for A4 paper DT5 in that order, the device processes, prints, and discharges these print-jobs in order of receiving. When A4 paper is exhausted in the process of printing the print-job DT1 after the device receives print-jobs in order as shown in FIG. 5A, the entire printing operation is halted even if B4 paper and A3 paper are still in other paper feeding cassettes.

To avoid a decline of effectiveness due to the aforementioned halting, a second related art which temporally stores a print-job for A4 paper in a memory or a hard disc of a printing device when A4 paper is exhausted and prints print-jobs for paper other than A4 before print-jobs for A4 paper is known (see, for example, Japanese Unexamined Patent Application, Publication No. H10-17168). FIGS. 6A to 7 are diagrams showing printing operations of a printing device of the aforementioned second related art. In a normal operation, when the device receives print-jobs consisting of a print-job for A4 paper DT1, a print-job for B4 paper DT2, a print-job for A4 paper DT3, a print-job for A3 paper DT4, and a print-job for A4 paper DT5 in that order, the device processes and prints these print-jobs in order of receiving, and printed paper is stacked in a catch tray as shown in FIGS. 6A and 6B. When A4 paper is exhausted in the process of printing the print-job DT1 as shown in FIG. 7, the printing device temporally stores the print-job DT1 in a storage unit such as a memory or a hard disc provided therein and the print-job DT2 for B4 paper is printed before the print-job DT1 and stacked in the catch tray. Since the print-job DT3 is for A4 paper, it is also temporally stored in the storage unit and the print-job DT4 for A3 paper is printed and stacked in the catch tray. Then the print-job DT5 is temporally stored in the storage unit. The print-jobs temporally stored in the storage unit are printed after A4 paper is supplied to a paper feeding cassette and ongoing printing is finished.

In printing devices of the second related art, printed paper of the halted print-job due to paper exhaustion (hereinafter, simply referred to as “the unfinished print”) and printed paper of other print-jobs are stacked in one catch tray. Since the unfinished print is left in the catch tray until the paper is supplied to the paper feeding cassette and the rest of the print-job is printed, there has been a problem in that the unfinished print may be lost by being taken away with printed paper of the other print-job by other users sharing the printing device.

In addition, many conventional printing devices are fixedly set to resume printing from the page printed before the halt due to the paper exhaustion. Therefore, there has been a problem in that users cannot change the configuration on resuming printing in accordance with conditions of the printing devices.

### SUMMARY OF THE INVENTION

The present invention was made to solve the aforementioned problems and thus it is an object to provide a printing device which can prevent printed paper from going missing due to mixture of different sizes of paper being stacked in a catch tray. In addition, it is an object to provide a printing device in which configurations on resuming halted print-job due to paper exhaustion can be set in accordance with conditions of the printing devices.

A first aspect of the present invention is a printing device which receives and prints job-data, including: a printing unit which prints the job-data; a memory which stores the job-data; a first cassette which feeds paper to the printing unit; a second cassette which feeds paper of different size from paper fed by the first cassette to the printing unit; a first tray in which paper printed by the printing unit is stacked; a second tray which is provided separately from the first tray and paper printed by the printing unit is stacked therein; and a first controller which makes the printing device store one of the job-data in the memory, the one of the job-data being one which is not printed due to paper exhaustion of one of the first cassette and the second cassette, print other job-data which is to be printed using the other cassette by the printing unit, and stack printed paper in the second tray.

The printing device of the present invention may further include a second controller which sets the printing of the job-data which is not printed to one of resuming from a page printed before the halt, printing from the first page of the job-data, and canceling the printing of the job-data based on a user's choice.

A second aspect of the present invention is a printing device which receives and prints job-data, including: a printing unit which prints the job-data; a memory which stores the job-data; a first cassette which feeds paper to the printing unit; a second cassette which feeds paper of different size from paper fed by the first cassette to the printing unit; a tray in which paper printed by the printing unit is stacked; and a controller which makes the printing device store one of the job-data in the memory, the one of the job-data being one which is not printed due to paper exhaustion of one of the first cassette and the second cassette, print other job-data which is to be printed using the other cassette by the printing unit, and stack printed paper in the tray at a position which is displaced a predetermined length in the lateral direction with respect to the feeding direction from a stacking position in a normal operation.

### BRIEF DESCRIPTION OF THE DRAWINGS

FIG. 1 is a block diagram showing a constitution of a printing device according to an embodiment of the present invention.

FIGS. 2A and 2B are diagrams showing an operation of the printing device shown in FIG. 1 when printing is halted due to paper exhaustion.

FIG. 3 is a diagram showing paper feeding cassettes of the printing device shown in FIG. 1.

FIGS. 4A and 4B are diagrams showing a normal printing operation of a printing device of the first related art.

FIGS. 5A and 5B are diagrams showing an operation of the printing device of the first related art when printing is halted due to paper exhaustion.

FIGS. 6A and 6B are diagrams showing a normal printing operation of a printing device of the second related art.

FIG. 7 is a diagram showing an operation of the printing device of the second related art when printing is halted due to paper exhaustion.

### DETAILED DESCRIPTION OF THE INVENTION

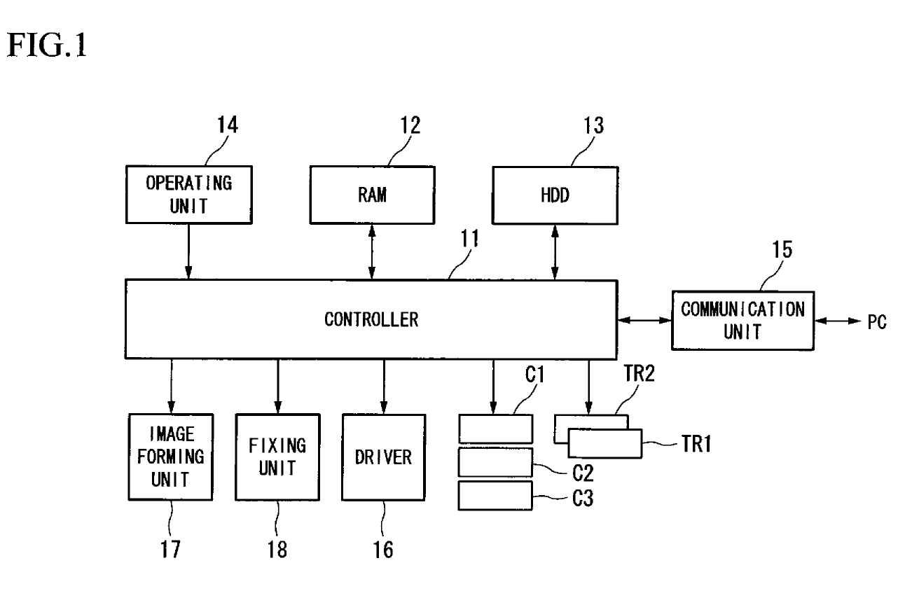

An embodiment of the present invention is described hereinbelow. FIG. 1 is a block diagram showing a constitution of a printing device according to the present embodiment. The printing device of the present embodiment includes a controller 11 constituted of a microprocessor and a Read Only Memory (ROM) having a program of the microprocessor stored therein. The controller 11 controls the whole printing device. The printing device also includes a Random Access Memory (RAM) 12 for temporary data storage, a Hard Disc Drive (HDD) 13 for temporary data storage in which font data and print-job data (data to be printed: hereinafter, simply referred to as print-job) is stored, an operating unit 14 allowing users to set configuration of the printing device, a communication unit 15 which receives print-jobs sent from a user's computer via a Local Area Network (LAN) and sends them to the controller 11, a driver 16 which drives mechanical components for supplying, discharging, and sending paper, paper feeding cassettes C1, C2, and C3 as feeding sources of paper, an image forming unit 17 which forms a non-fixed toner image (non-fixed image) by copying a non-fixed image on paper fed from the feeding cassettes C1, C2, and C3, a fixing unit 18 which fixes the non-fixed image, and catch trays TR1 and TR2 in which paper is stacked after being fixed by the fixing unit 18.

A print-job includes one or more page-data, a size of paper to be printed thereon, and page number assigned to each page-datum. In this embodiment, users can set a primary catch tray in which printed paper is usually stacked and a secondary catch tray via the operating unit 14. The secondary catch tray is used when paper exhaustion of one of the sizes of paper stored in the printing device occurs, and printed paper of sizes other than the exhausted size is stacked therein.

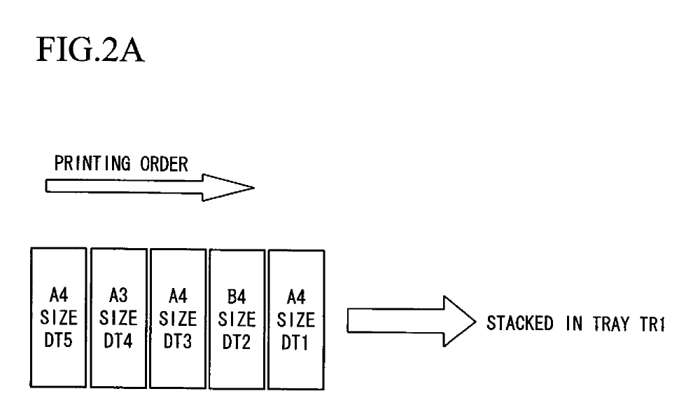

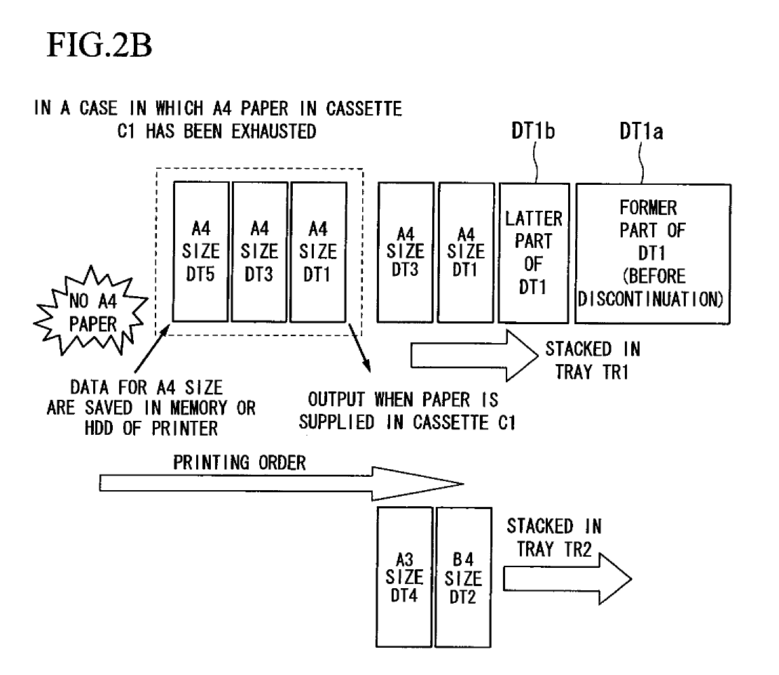

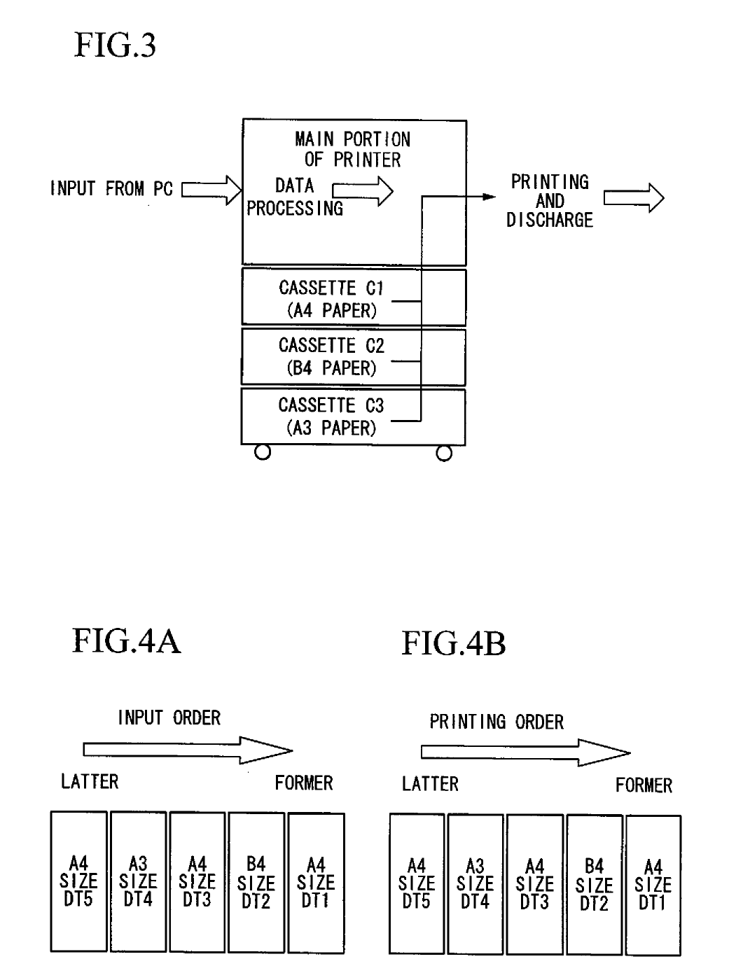

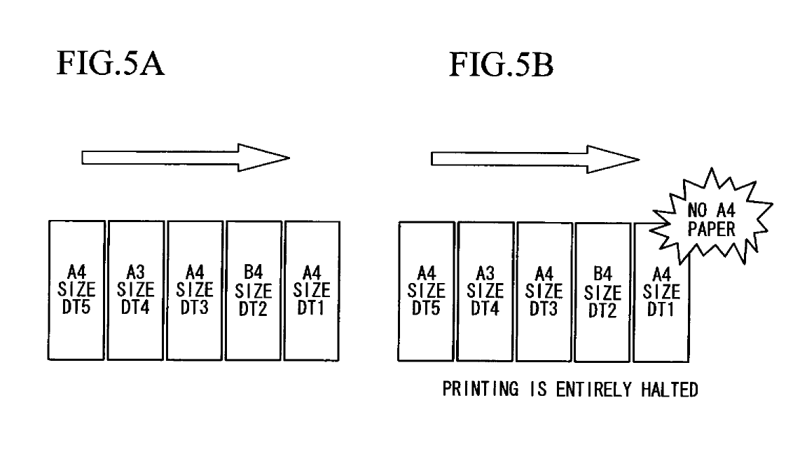

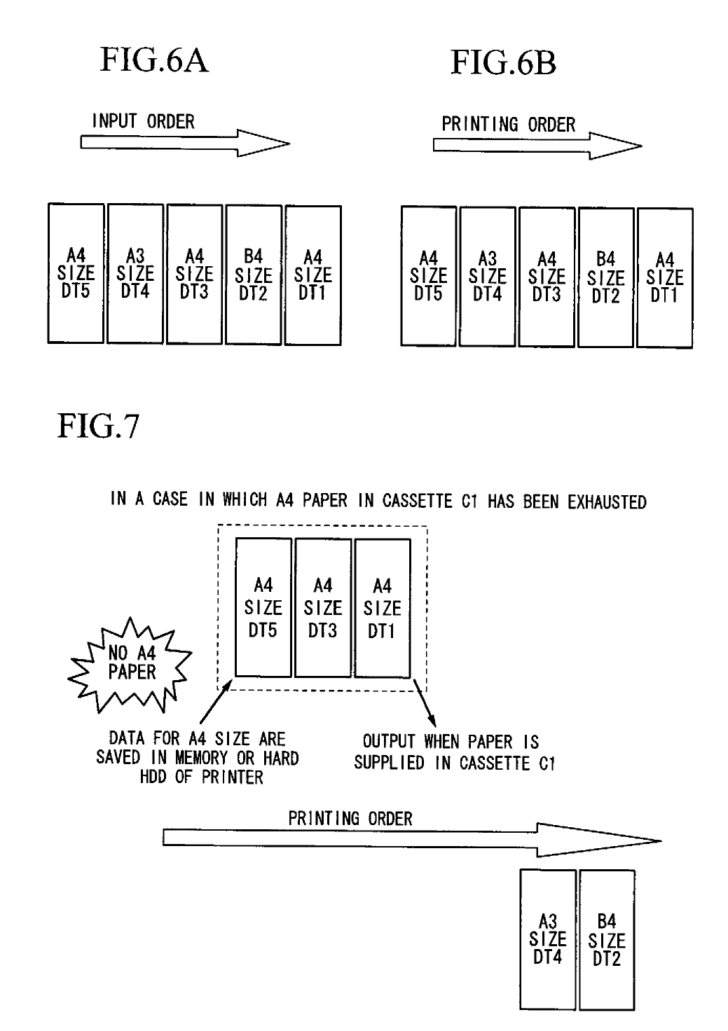

The operations of the aforementioned embodiment are described with reference to the drawings. FIG. 2A is a diagram showing a normal operation of the present embodiment and FIG. 2B is a diagram showing a condition when printing of print-jobs is halted. First, a user sets the tray TR1 as the primary catch tray via the operating unit 14 and sets the tray TR2 as the secondary catch tray. When the communication unit 15 receives a print-job for A4 paper DT1, a print-job for B4 paper DT2, a print-job for A4 paper DT3, a print-job for A3 paper DT4, and a print-job for A4 paper DT5 in that order via the LAN, the communication unit 15 sends these print-jobs to the controller 11. The controller 11 stores these print-jobs in the HDD 13.

When these print-jobs are printed, the controller 11 obtains the print-job DT1 and confirms the size of paper which is set thereto. If A4 paper which is set to the print-job DT1 is stored in the cassette for A4 paper (e.g., the cassette C1), the controller 11 makes the driver 16 feed A4 paper to the image forming unit 17. The driver 16 feeds A4 paper from the cassette C1. The image forming unit 17 forms a non-fixed image by copying a toner image on the paper fed by the driver 16. The non-fixed image is fixed by the fixing unit 18. Then the controller 11 commands the driver 16 to stack printed paper in the tray TR1 and the driver 16 performs the command. During these processes, the controller 11 checks whether or not the last page of the print-job DT1 is being printed. If the last page is being printed, the controller 11 deletes the print-job DT1 from the HDD 13 after the printing of the last page is finished and terminates the printing of the print-job DT1. If the last page has not been printed yet, the next page of the print-job DT1 is printed in the same manner. After the print-job DT1 is printed and deleted from the HDD 13, the next print-job DT2 is printed in the same manner.

A case where exhaustion of A4 paper occurs in the process of printing the print-job DT1 is described with reference to FIG. 2B. In this case, paper on which a fragment DT1a of the print-job DT1 is printed has already been stacked in the tray TR1. When paper exhaustion occurs, the controller 11 stores the print-job DT1 in a storage device such as the RAM 12 or the HDD 13. Then the controller 11 obtains the print-job DT2 for B4 paper from the HDD 13 and prints it. The controller 11 automatically switches the tray in which printed paper is stacked, from the tray TR1 to the tray TR2. The driver 16 stacks printed paper in the tray TR2.

Since A4 paper is exhausted, the print-job DT3 for A4 paper is stored in the aforementioned storage device by the controller 11. Then the print-job DT4 for A3 paper is printed and printed paper is stacked in the tray TR2 by the driver 16. The print-job DT5 for A4 paper is also stored in the storage device by the controller 11. With respect to the print-jobs DT1, DT3, and DT5, the controller 11 resumes printing them when an ongoing printing is finished after A4 paper has been supplied to the cassette C1.

At this time, the user can select one of three operation modes for resuming printing. In the first mode, the printing is resumed from the next page of the lastly-printed page of the print-job halted due to paper exhaustion (hereinafter, simply referred to as “the halted print-job”). In the second mode, the halted print-job is printed again from the first page. In the third mode, the printing of the halted print-job is cancelled. These three operation modes in a case shown in FIG. 2B, where paper exhaustion occurs in the process of printing the print-job DT1, are specifically described.

If the first mode is selected, the controller 11 obtains the print-job DT1 from the storage device and printing of the print-job DT1 is resumed from the next page of the lastly-printed page before paper exhaustion. Then other print-jobs for A4 paper (e.g., the print-jobs DT3 and DT5) are printed and printed paper is stacked in the tray TR1 by the driver 16. If the second mode is selected, the controller 11 obtains the print-job DT1 from the storage device and printing of the print-job DT1 is resumed from the first page. Other print-jobs are printed and printed paper is stacked in the same manner as in the first mode. If the third mode is selected, the controller 11 deletes the print-job DT1 from the storage device. Therefore, the print-job DT1 is not printed.

In the present embodiment, although printed paper of the print-job for A4 paper and that of other print-jobs are stacked in different catch trays in a case shown in FIG. 2B, all of the printed paper may be stacked in the tray TR1. In this case, the printed paper of the print-job for paper other than A4 paper may be stacked at a position which is displaced a predetermined length in the lateral direction with respect to the feeding direction from a stacking position in normal operation. The printed paper of the halted print-job and that of the other print-jobs can be distinguished thereby in this case.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A printing device which receives and prints job-data, comprising:
a printing unit which prints the job-data;
a memory which stores the job-data;
a first cassette which feeds paper to the printing unit;
a second cassette which feeds paper of different size from paper fed by the first cassette to the printing unit;
a first tray in which paper printed by the printing unit is stacked;
a second tray which is provided separately from the first tray and paper printed by the printing unit is stacked therein; and
a first controller which makes the printing device store one of the job-data in the memory, the one of the job-data being one which is not printed due to paper exhaustion of one of the first cassette and the second cassette, print other job-data which is to be printed using the other cassette by the printing unit, and stack printed paper in the second tray.

2. The printing device according to claim 1, further comprising:
a second controller which sets the printing of the job-data which is not printed to one of resuming from a page printed before the halt, printing from the first page of the job-data, and canceling the printing of the job-data based on a user's choice.

3. A printing device which receives and prints job-data, comprising:
a printing unit which prints the job-data;
a memory which stores the job-data;
a first cassette which feeds paper to the printing unit;
a second cassette which feeds paper of different size from paper fed by the first cassette to the printing unit;
a tray in which paper printed by the printing unit is stacked; and
a controller which makes the printing device store one of the job-data in the memory, the one of the job-data being one which is not printed due to paper exhaustion of one of the first cassette and the second cassette, print other job-data which is to be printed using the other cassette by the printing unit, and stack printed paper in the tray at a position which is displaced a predetermined length in the lateral direction with respect to the feeding direction from a stacking position in a normal operation.
